(19) United States
(12) Patent Application Publication
(10) Pub. No.: US 2005/0166672 A1
(43) Pub. Date: Aug. 4, 2005

(54) Acoustic devices and fluid gauging

(75) Inventor: Harry Atkinson, Berkshire (GB)

Correspondence Address: CONNOLLY BOVE LODGE & HUTZ LLP, SUITE 800, 1990 M STREET NW, WASHINGTON, DC, 20036-3425, US

(73) Assignee: Smiths Group plc, London (GB)

(21) Appl. No.: 11/045,086

(22) Filed: Jan. 31, 2005

(30) Foreign Application Priority Data
Jan. 30, 2004 (GB) 0402007.9

(51) Int. Cl. G01F 23/00

(52) U.S. Cl. 73/290 V

(57) ABSTRACT

An ultrasonic probe for gauging fuel or other fluids has a still well mounted in the tank and an acoustic device mounted towards the lower end of the still well. The acoustic device includes a piezoelectric member with a flat upper surface and a lower surface that is profiled such that the thickness of the member varies across its width. In this way, the piezoelectric member has several resonant frequencies and information can be extracted using frequency domain techniques.

### BACKGROUND OF THE INVENTION

This invention relates to acoustic devices and to acoustic fluid-gauging apparatus.

Ultrasonic liquid-gauging probes, such as for measuring the height of fuel in an aircraft fuel tank, are now well established and examples of systems employing such probes can be seen in U.S. Pat. No. 5,670,710, GB2380795, GB2379744, GB2376073, U.S. Pat. Nos. 6,598,473 and 6,332,358. The probe usually has a tube or still well extending vertically in the fuel tank and a piezoelectric ultrasonic transducer mounted at its lower end. When the transducer is electrically energized it generates a burst of ultrasonic energy and transmits this up the still well, through the fuel, until it meets the fuel surface. A part of the burst of energy is then reflected down back to the same transducer. By measuring the time between transmission of the burst of energy and reception of its reflection, the height of fuel in the still well can be calculated.

The piezoelectric transducer is normally driven at its thickness mode resonant frequency so that the maximum acoustic energy is produced four a given electrical input. The resonant frequency of the transducer in this mode is predominantly a function of the thickness of the piezoelectric material and to a much less extent is dependent on the piezoelectric material and the temperature. The frequency response of such transducers is typically given by a plot of the kind shown in FIG. 2. It can be seen that the energy rapidly drops away from the resonant frequency and that the bandwidth at an arbitrary −6 dB level is relatively narrow. This can create problems in gauging systems because frequency domain techniques are often used to manipulate the information and, to do this, the bandwidth should be as large as possible.

### BRIEF SUMMARY OF THE INVENTION

It is an object of the present invention to provide an alternative acoustic device and fluid-gauging apparatus.

According to one aspect of the present invention there is provided an acoustic device including a piezoelectric member arranged to generate acoustic energy by resonating through its thickness, the member having a thickness that is different at different locations across the width of the member.

The piezoelectric member preferably has one surface that is flat and an opposite surface that is profiled, the member being arranged to propagate acoustic energy from the flat surface. The thickness of the member may vary in a stepped fashion or it may vary gradually across its width.

According to another aspect of the present invention there is provided a fluid-gauging probe including a still well and an acoustic device according to the above one aspect of the present invention mounted at one end of the still well.

According to a farther aspect of the present invention there is provided a fluid-quantity gauging system including at least one acoustic device according to the above one aspect of the present invention and means connected with the acoustic device for energizing the device and for analyzing signals received by the device.

According to a fourth aspect of the present invention there is provided a fluid-gauging system including at least one fluid-gauging probe according to the above other aspect of the present invention and means connected with the probe for energizing the acoustic device and for analyzing signals received by the device.

The means connected with the acoustic device is preferably arranged to process information from the acoustic device using frequency domain techniques.

An aircraft fuel-gauging system including a probe having an acoustic device according to the present invention, will now be described, by way of example, with reference to the accompanying drawings.

### BRIEF DESCRIPTION OF THE DRAWINGS

FIG. 1 illustrates schematically a conventional fuel-gauging system;

FIG. 2 is a simplified graph showing the system transfer function of the arrangement in FIG. 1;

FIG. 3 illustrates a system having a piezoelectric transducer according to the present invention;

FIG. 4 is a simplified graph showing the system transfer function of the arrangement in FIG. 3;

FIG. 5 illustrates a system having a modified transducer;

FIG. 6 is a simplified graph showing the system transfer function of the arrangement in FIG. 5;

FIG. 7 illustrates another system having a modified transducer; and

FIG. 8 is a simplified graph showing the system transfer function of the arrangement in FIG. 7.

### DETAILED DESCRIPTION OF THE PREFERRED EMBODIMENTS

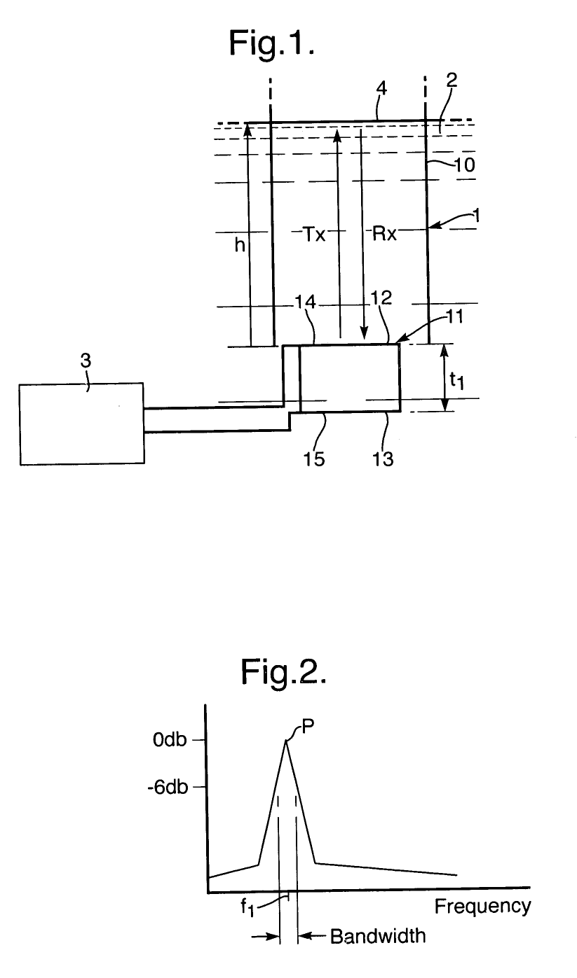

With reference first to FIGS. 1 and 2 there is shown a conventional fuel-gauging system comprising a probe 1 mounted projecting vertically, or substantially vertically, upwardly from the floor of a fuel tank (not shown). The probe 1 has a tubular still well 10 and an acoustic device in the form of a piezoelectric transducer 11 mounted at the lower end of the still well so that it is immersed in any fuel 2 that is present. The transducer is usually mounted in a housing that is acoustically-transparent at the frequency of operation so as to protect the piezoelectric ceramic from direct contact with fuel. A foam pad (not shown) or the like on the lower surface of the transducer provides damping. The transducer 11 has a circular disc shape arranged with its upper and lower surfaces 12 and 13 orthogonal to the axis of the still well 10. The upper and lower surfaces 12 and 13 are flat and parallel so that the transducer 11 has a constant thickness of ti at all points across its width. Electrodes 14 and 15 on the upper and lower surface 12 and 13 are connected to a drive and processing unit 3. The unit 3 is arranged to apply bursts of alternating voltage to the electrodes 14 and 15 to energize the transducer 11 to resonate and produce bursts of ultrasonic energy from its upper and lower surfaces 12 and 13. The energy from the lower surface 13 is absorbed in the mounting of the transducer 11 whereas the energy propagated from the upper surface 12 is directed upwardly through the fuel 2 within the still well 10 for measurement purposes, as shown by the arrow labelled Tx. When the ultrasound energy meets the fuel surface 4, where there is a fuel/air interface, the major part of the energy is reflected back down the still well 10, as indicated by the arrow labelled Rx. The reflected acoustic energy is incident on the upper surface 12 of the transducer 11, which converts the acoustic energy back into electric energy in the form of a burst of alternating voltage. This burst of alternating voltage is supplied to the processing unit 3, which measures the time between transmission and reception of the ultrasonic energy and calculates the height h of fuel within the still well 10 in the usual way from knowledge of the speed of transmission of the acoustic energy. It will be appreciated that in most systems there will be several probes distributed about the tank in order to measure the height at different locations.

The transducer 11 is driven in its thickness mode of resonance so its resonant frequency is largely dependent on the thickness t₁ of the transducer. The efficiency at which the electrical energy is converted to acoustic energy is high very close to the resonant frequency f₁ where there is a single, sharply-defined peak P. The energy drops rapidly away from this, as shown in FIG. 2, where it can be seen that the bandwidth is relatively narrow.

As described above, the system and transducer are conventional.

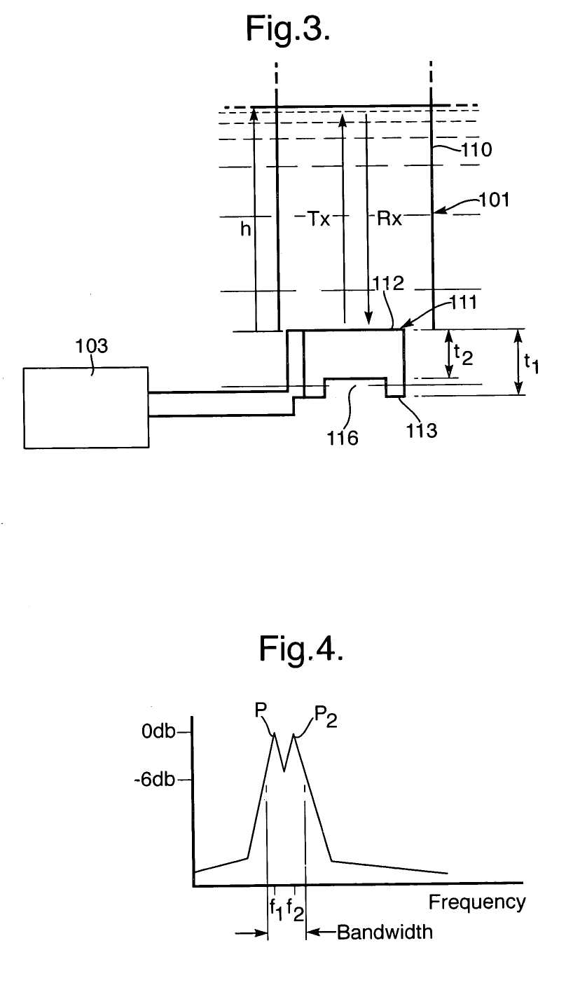

With reference now to FIGS. 3 and 4, there is shown one example of a system according to the present invention. Components similar to those in FIG. 1 have been given the same reference number with the addition of 100. The system has a probe 101 with a still well 110 and a piezoelectric transducer 111 mounted at its lower end and connected with a processing unit 103. The transducer 111 is in the form of a circular piezoelectric disc member but it could have various other non-circular sections. The transducer 111 differs from conventional transducers in that its thickness is different at different points across the width of its surface. In particular, the upper surface 112 of the transducer 111 is flat whereas its lower surface 113 has a central recess 116 so that the thickness t₂ of the transducer in the central region is less than the thickness t₁ around its periphery. This difference in thickness means, in effect, that the transducer 111 has two resonant frequencies f₁ and f₂ dictated by the thicknesses t₁ and t₂. The system transfer function for this transducer 111 is shown in FIG. 4 and it can be seen that it has two peaks P₁ and P₂ leading to an appreciably broader bandwidth. This is an advantage because it enables the processing unit 103 more reliably to manipulate information extracted from the transducer 111 using frequency domain techniques.

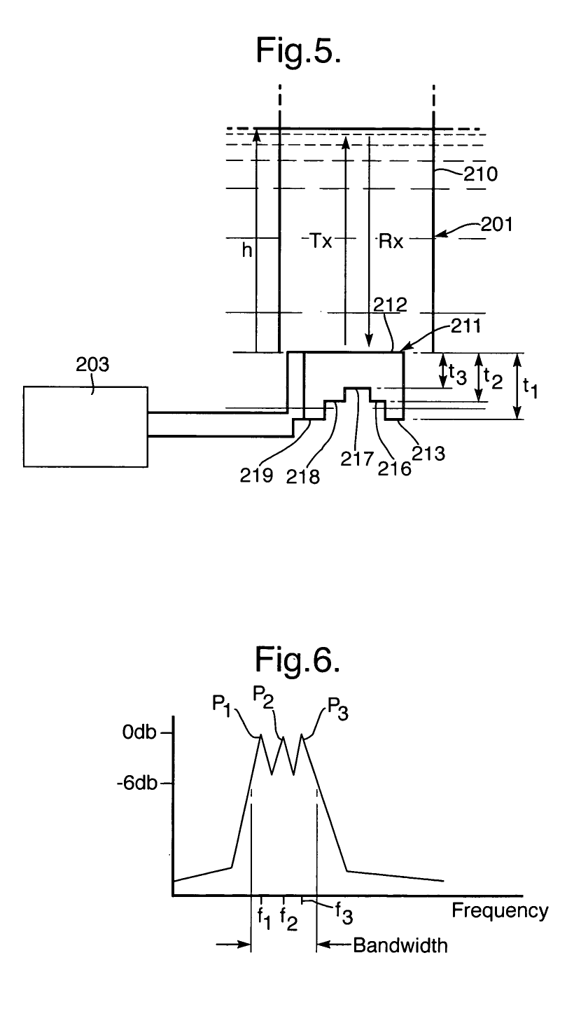

FIGS. 5 and 6 show a system having another form of modified transducer where similar components have been given the same reference numbers as those in FIG. 1 but with the addition of 200. The transducer 211 also varies in thickness across its surface, having a flat upper surface 212 and a stepped recess 216 on its lower surface 213 providing a central portion 217 of the smallest thickness t₃, an annular ledge 218 surrounding the central portion and having a greater thickness t₂, and a peripheral rim 219 of greatest thickness ti These three different thicknesses give the transducer 211 three different resonant frequencies as shown by the three peaks P₁, P₂ and P₃ in the graph of FIG. 6. It can be seen that these three frequencies lead to an even greater broadening of the bandwidth than the transducer 111 of FIG. 3.

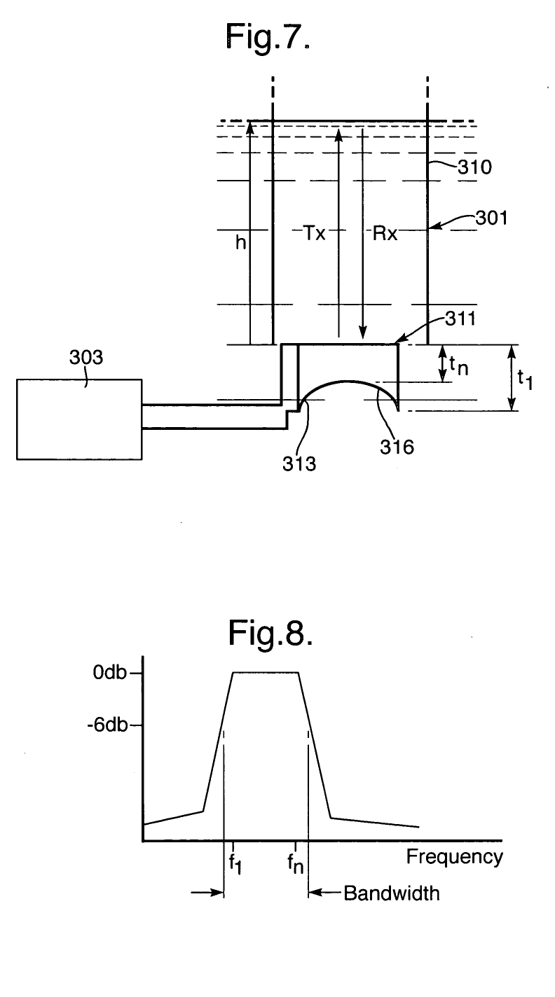

FIG. 7 shows a further way in which a transducer 311 can be provided. The lower surface 313 of the transducer 311, instead of having a stepped profile as in the arrangements shown in FIGS. 3 and 5, has a curved profile extending across its entire surface 313 and providing a concave recess 316 with a continuously varying thickness across its diameter, from a minimum of tₙ at its centre to t₁ at its edge. This gives a system transfer function of the kind shown in FIG. 8 having a flat peak and a relatively broad bandwidth.

It will be appreciated that transducers could have various different profiles. Although the shapes described above are all thinnest in the centre, the shape of the transducer could be different from this, such as having its thinnest region towards the edge. Preferably, as described above, the upper surface of the transducer is flat and the profile is provided on its lower surface. It might, however, be possible instead to have a non-flat profile on the upper surface, or on both the upper and lower surfaces. The invention is not confined to fuel-quantity gauging but could be used in other applications involving acoustic devices.

1. An acoustic device comprising a piezoelectric member arranged to generate acoustic energy by resonating through its thickness, wherein said member has a thickness that is different at different locations across a width of said member.

2. An acoustic device according to claim 1, wherein said piezoelectric member has one surface that is flat and an opposite surface that is profiled.

3. An acoustic device according to claim 2, wherein said piezoelectric member is arranged to propagate energy for measurement purposes from said flat surface.

4. An acoustic device according to claim 1, wherein the thickness of said piezoelectric member varies across its width in a stepped fashion.

5. An acoustic device according to claim 1, wherein the thickness of said piezoelectric member varies gradually across its width.

6. A fluid-gauging probe comprising: a still well and an acoustic device mounted at one end of said still well, wherein said acoustic device includes a piezoelectric member with a thickness that is different at different locations across a width.

7. A fluid-gauging probe according to claim 6, wherein said piezoelectric member has a flat surface directed towards an opposite end of said still well from which acoustic energy is propagated along said still well, and wherein said piezoelectric member has a stepped profile on an opposite surface.

8. A fluid-gauging probe according to claim 6, wherein said piezoelectric member has a flat surface directed towards an opposite end of said still well from which acoustic energy is propagated along said still well, and wherein said piezoelectric member has a curved profile on an opposite surface.

9. A fluid-gauging system comprising a drive unit and at least one acoustic device connected with said drive unit such that said drive unit energizes said acoustic device to propagate acoustic energy, wherein said acoustic device includes a piezoelectric member having a thickness that is different at different locations across its width such that the acoustic device is resonant at a plurality of different frequencies.

10. A fluid-gauging system according to claim 9 including a still well for each said acoustic device, wherein each said acoustic device is mounted towards the lower end of a respective one of said still wells, and wherein said still wells are mounted to extend upwardly from the floor of a fluid tank.

11. A fluid-gauging system according to claim 9, wherein each said piezoelectric member has a substantially flat upper surface and is profiled on its lower surface such that the thickness of the member varies across its width.

12. A fluid-gauging system according to claim 9, wherein the system is arranged to process information from the acoustic device using frequency domain techniques.
